(19) United States
(12) Patent Application Publication
(10) Pub. No.: US 2008/0208863 A1
(43) Pub. Date: Aug. 28, 2008

(54) Compound Item Locking Technologies

(75) Inventors: Richard L. Negrin, Mercer Island, WA (US); Amit Shukla, Redmond, WA (US); David J. Nettleton, Seattle, WA (US); Jack S. Richins, Bothell, WA (US); Gregory S. Friedman, Redmond, WA (US); Lev Novik, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/680,367

(22) Filed: Feb. 28, 2007

(51) Int. Cl. G06F 17/30

(52) U.S. Cl. 707/8; 707/E17.007

(57) ABSTRACT

The present invention provides technologies including an item management system for the management of compound items and the storage of such items in tabular format using storage systems such as a database management system. Compound items may include file items which may be stored in a file format using storage systems such as a file system. The present invention further provides technologies for locking such compound items upon access by an application to preserve integrity of the items. In particular, the technologies allow for locking compound items including file items where the file items may be accessed via the item management system and/or via an associated file system.

### BACKGROUND

Modern computing software makes use of complex data items. Such a data item may be a compound of multiple types of data including files, database records, data fragments, relationships, properties, and the like. Modern computing software also typically provides concurrent access to such compound items resulting in a need to ensure the integrity of the items. For example, it is essential to ensure that one part of a compound item is not accessed or changed in a manner that is inconsistent with the remainder of the compound item. Locking can be used to protect access to an item and its elements thus ensuring consistency. But locking entire compound items can be expensive.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present examples describe technologies including an item management system for managing and locking items including compound items. In particular, the technologies allow for locking compound items including file items where the file items may be accessed via the item management system and/or via an associated file system.

Many of the attendant features will be more readily appreciated as the same become better understood by reference to the following detailed description considered in connection with the accompanying drawings.

### DESCRIPTION OF THE DRAWINGS

The present description will be better understood from the following detailed description considered in connection with the accompanying drawings, wherein:

FIG. 1 is block diagram showing an example system making use of an example software application including an example data item.

FIG. 2 is a block diagram showing an example hierarchy including compound data items and such.

FIG. 3 is a diagram showing a representation of an example database table with rows representing elements of a hierarchy.

FIG. 4 is a block diagram shown an example system for providing item management, storage, and access functionality for applications.

FIG. 5 is a block diagram showing an example LockRootItem method typically used by an application or the like in requesting a lock on an item.

FIG. 6 is a block diagram showing an example FSLockRootItem method typically used by a file system or the like when opening a file handle for a file item.

FIG. 7 is a block diagram showing an example computing environment in which the technologies described above may be implemented.

Like reference numerals are used to designate like parts in the accompanying drawings.

### DETAILED DESCRIPTION

The detailed description provided below in connection with the accompanying drawings is intended as a description of the present examples and is not intended to represent the only forms in which the present examples may be constructed or utilized. The description sets forth at least some of the functions of the examples and/or the sequence of steps for constructing and operating examples. However, the same or equivalent functions and sequences may be accomplished by different examples.

Although the present examples are described and illustrated herein as being implemented in a computing and networking system, the system described is provided as an example and not a limitation. As those skilled in the art will appreciate, the present examples are suitable for application in a variety of different types of computing and networking systems.

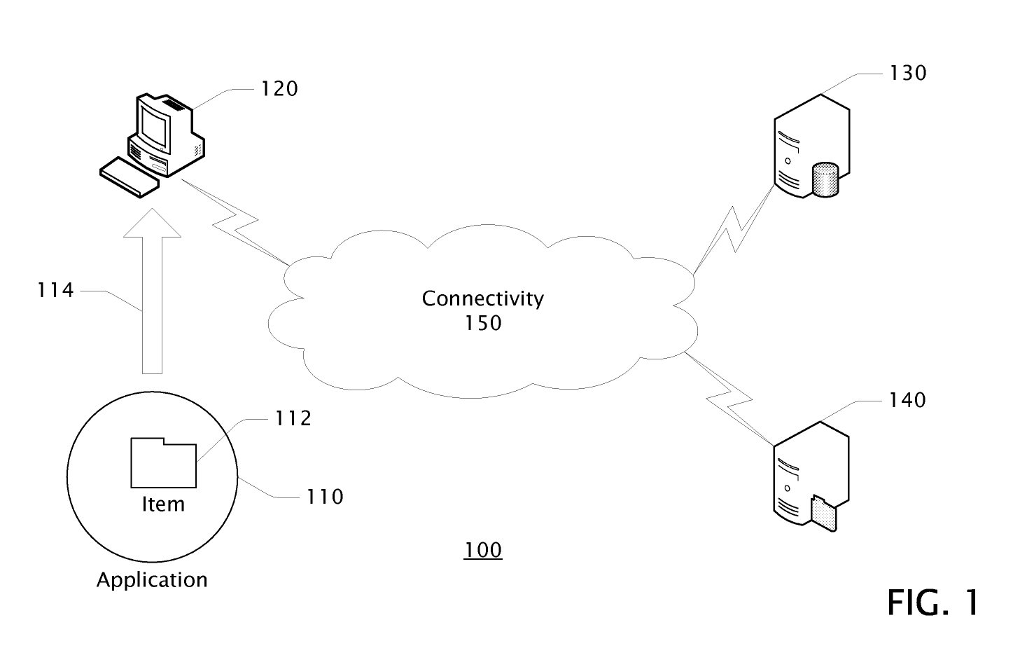

FIG. 1 is block diagram showing an example system 100 making use of an example software application 100 including an example data item 112. System 100 includes an example computing device 120 running application 110 as indicated by arrow 114. Application 110 includes data item 112 which may be a compound item. Portions of compound item 112 may be stored in a database via example database server 130 and/or in a file system via example file server 140 and/or in a run-time environment and/or in any other suitable system, environment, or the like. Servers 130 and 140 are generally each coupled to computing device 120 via connectivity 150 such as a network or other suitable connectivity. In alternative examples, application 110 may be a distributed application operating on a plurality of computing devices or systems, or it may be any other type of application, firmware, or the like making use of data items or the like. Additionally, database and file system functionality and the like, such as that provided by servers 130 and 140, may be provided via any means suitable such as the same computing device 120 hosting application 110 or by any other combination of systems or devices coupled via any suitable means.

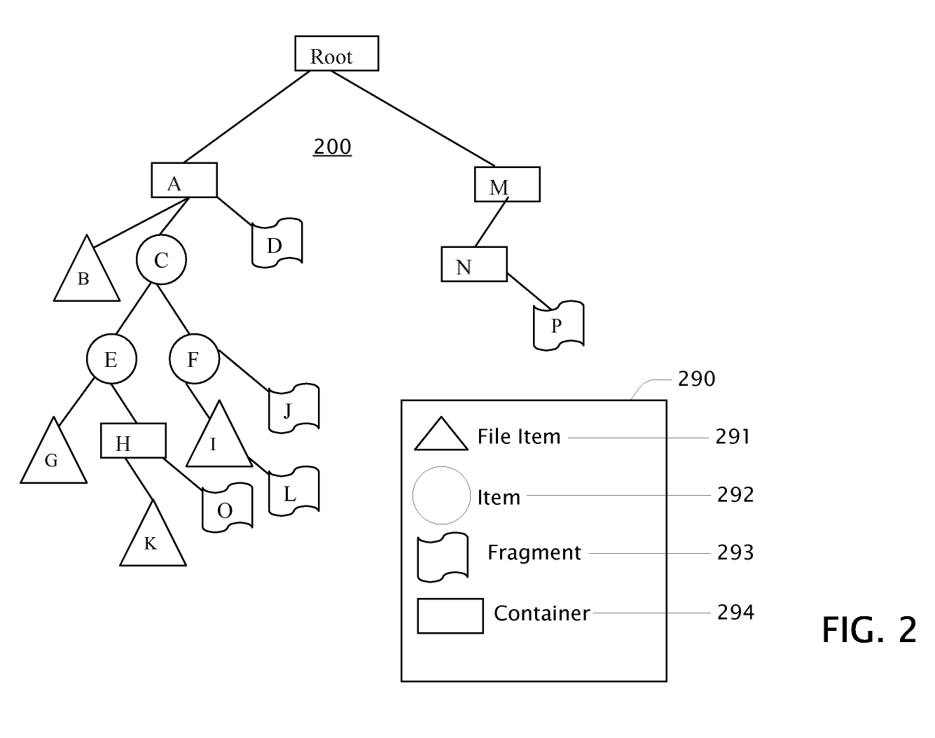

FIG. 2 is a block diagram showing an example hierarchy 200 including compound data items and such. Also shown is symbol key 290 identifying the various symbols used in the hierarchy, including a symbol for a file item 291, an item 292, a fragment 293, and a container 294. The hierarchy 200 is drawn as a tree structure with parent-child relationships between the elements, such as elements 291-294. The top element identifies the specific hierarchy 200 and, in this example, has an identifier (“ID”) of “Root”. The other elements in the hierarchy 200 each include an ID of a single letter from ‘A’ to ‘P’. The specific IDs used in the example are for illustration only; any suitable IDs or the like may be used in practice.

The symbol for file item 291 generally represents a data structure such as a file or the like and may include other data and/or metadata associated with and/or describing the file. Such as file is typically stored in and managed by a file system. Data associated with a file is typically represented in a row of a database table such that it can be queried.

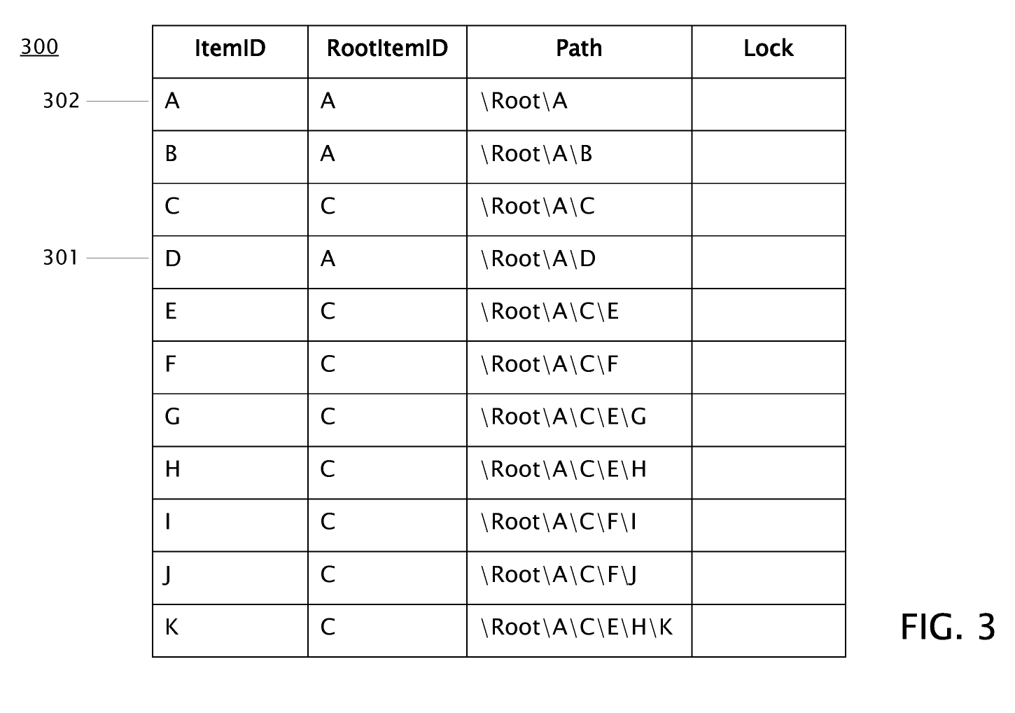

The symbol for item 292 generally represents a data structure typically comprising one or more data elements. Such data elements may be discreet data, a file item, data associated with a file item, a data fragment, or any other form or type of data. An item comprised of multiple such data elements is generally referred to as a compound item. In one example, an item or a compound item may be represented and/or stored in a database as a set of rows of a table, each data element stored in a single row as described more fully in connection with FIG. 3. Some data elements, such as a file item, may be stored via some other mechanism, such as a file system, with an associated data element typically being stored in a row, such as a path or a link to the file item. In this manner the various data elements of a compound item may be stored in or by a plurality of systems, such as database systems, file systems, run-time systems, and the like while a complete representation of the compound item is typically stored in rows of a database table or the like such that they can be queried.

The symbol for fragment 293 generally represents data typically associated with an immediate parent element in a hierarchy. One example of a fragment is a property, such as a characteristic or parameter of the parent. Another example, if the parent item is a folder, one fragment may be an icon used to graphically represent the folder on a display. A fragment is typically represented in a row of a database table such that it can be queried.

The symbol for container 294 generally represents organization structure in the hierarchy 200. A container is analogous to a folder or a directory in a file system. A container may include data elements, child fragments, child containers, child file items, and/or child items and child compound items. A container is typically represented in a row of a database table such that it can be queried.

Hierarchy 200 includes an example compound item tree for compound item ‘C’ which has two immediate children, items ‘E’ and ‘F’, each of which include other child data elements. The parent of item ‘C’ is container ‘A’ with no items above it in hierarchy 200, thus compound item ‘C’ is also known as the root item of compound item ‘C’ as it is the top-level item in the compound item tree designated by item ID ‘C’. In general, the top-level item of a compound item tree is known as the root item of the compound item. In alternate examples, any other combination of elements arranged in any hierarchical structure suitable for representing a compound item may be used.

Hierarchy 200 also includes an example container ‘A’ which has two immediate children, file item ‘B’ and fragment ‘D’. Container ‘A’ is known as the root item of container ‘A’ and file item ‘B’ and fragment ‘D’. But container ‘A’ is not the root item for compound item ‘C’ because it is a container element and not an item element. Typically only item elements (as opposed to file item elements) can be the root item for other child item elements. Such a limitation contributes to storage systems that intermingle file and object content, such as the system described herein, to maintain a high degree of compatibility with storage systems which can only contain files, such as file systems. An example of container ‘A’ is a folder containing a file, such as file item ‘B’ and having a folder name, such as fragment ‘D’.

The term “item” as used herein may refer to any of the specific types of elements described in connection with FIG. 2, a compound item, an item comprised of a single element, an item comprised of multiple elements but no child items, or the like, as well as containers, fragments, and file items.

FIG. 3 is a diagram showing a representation of an example database table 300 with rows representing elements of hierarchy 200 of FIG. 2. Example table 300 includes columns for ItemID, RootItemID, and Path. Each row in the ItemID column contains an item ID for an element in the hierarchy. Each corresponding row in the RootItemID column contains the item ID for the root item of the element in the row. Each corresponding row in the Path column contains the path in the hierarchy of the element in the row. Table 300 and the columns shown are provided as examples; in practice any table structure and/or columns may be used, with any suitable formatting of the data. Further, table 300 may be maintained in system memory or a cache and/or may be augmented with indices or the like such that access time is minimized.

In one example, table 300 includes a Lock column. Such a column may be used to indicate the taking of a lock on an element in the table. For example, if a lock is taken on element ‘D’ in table 300 (row 301), then the lock would be indicated in the Lock column of row 301. Further, when a lock is taken on an element, such as element ‘D’ in table 300 (row 301), a lock is also taken on the corresponding root item, as typically indicated in the RootItemID column. In this example, the root item is element ‘A’ in table 300 (row 302). By taking such a lock on the root item, the entire compound item is locked whenever any element of the compound item is locked. Thus, given an attempt to access any element of a compound item, the RootItemID column of that item can be checked to identify the root item, and then the root item can be checked for a lock. If the root item is locked then access to any element of the item may be denied. This approach provides for efficient locking of a compound item, the efficiency stemming from the single level of indirection from any item to the root item as provided by the RootItemID column. Furthermore, this approach provides for a coarse-grained locking model in which the members of a compound item are generally not locked independently. For example, an entity that wishes to effect changes to a portion of a compound item must generally lock the entire compound item (coarse-grained locking), preventing other entities from effecting concurrent changes to elements of the compound item, until the lock is released. In cases where various elements within a compound item are related and must co-vary, this model enables entities to atomically change such elements of the compound item from one valid state to another. Once a lock has been taken on an item and any changes have been committed, the lock is typically released. In alternative examples, lock indications may be maintained in another table or tables, such as a database system table, other than example table 300, and/or in system memory, and/or in any other suitable data structure.

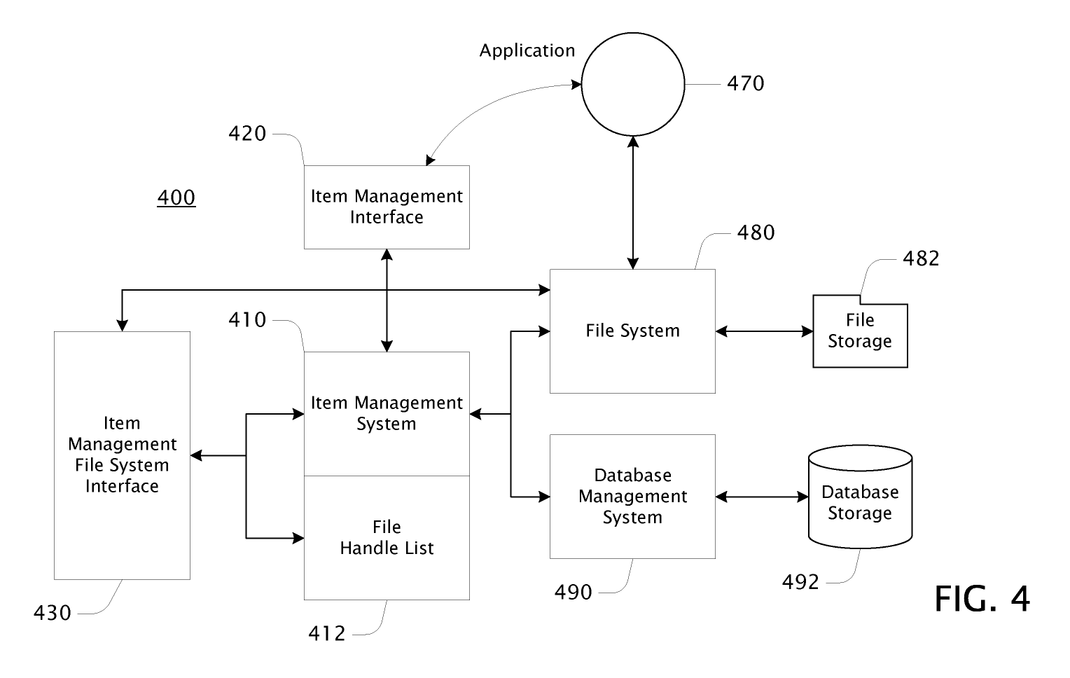

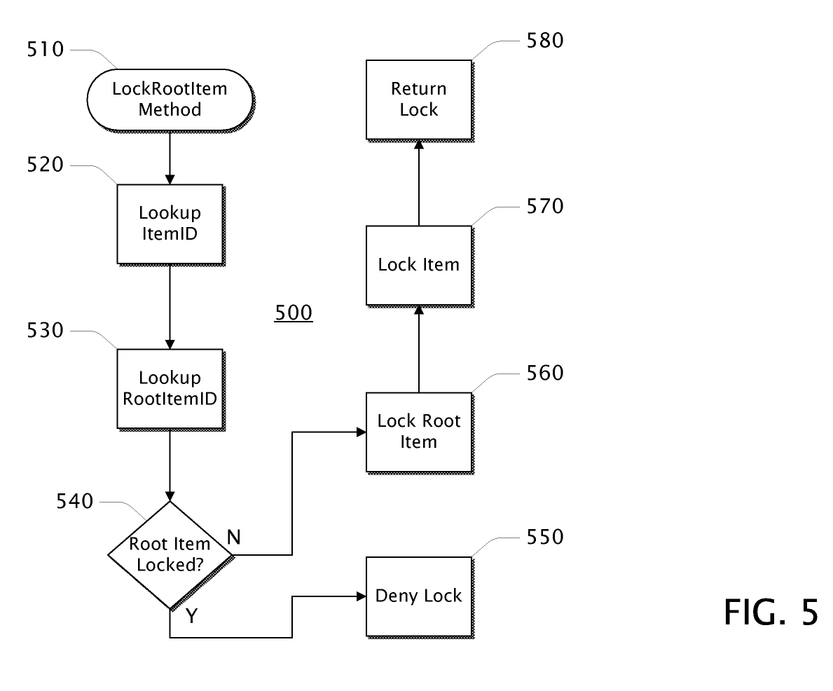

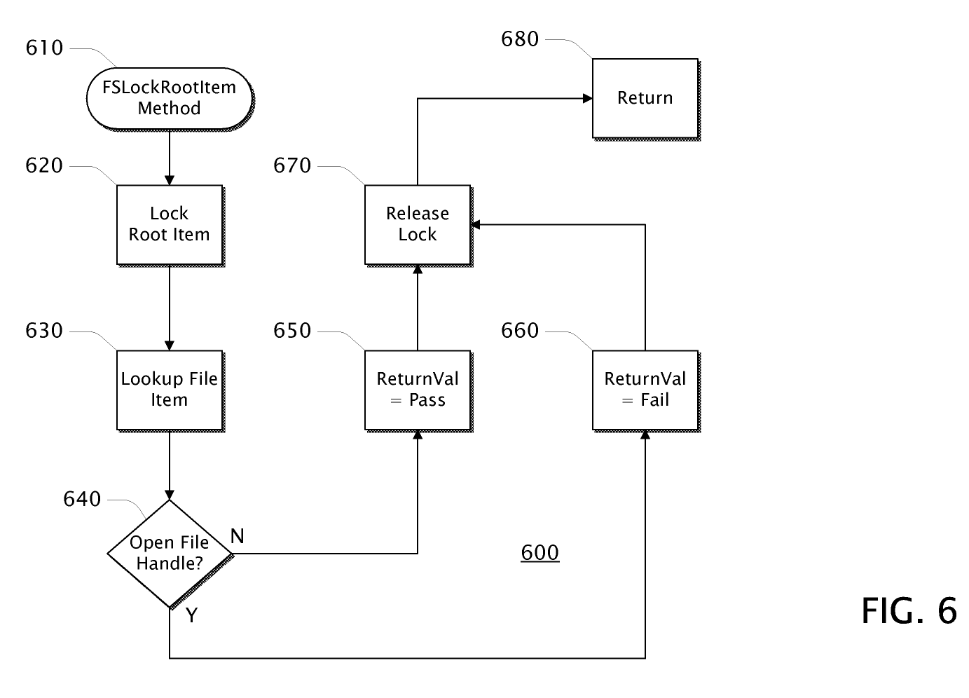

FIG. 4 is a block diagram shown an example system 400 for providing item management, storage, and access functionality for applications such as example application 470. Such applications may be associated with system 400 only by their usage of such a system. Such applications may include email applications, user applications, or any other type of application that may benefit from item storage and access functionality. System 400 typically provides functionality for managing, access, storage, and such, of items, including methods such as those described in connection with FIG. 5 and FIG. 6. The arrows of system 400 as shown in FIG. 4 indicate some of the example communications, interactions and data flows between elements of system 400 but do not represent the only communications, interactions or the like.

Item management system (“IMS”) 410 typically provides functionality for managing, accessing, and controlling the storage of items. This functionality includes creating, deleting, modifying, accessing, storing, and any other form of access, control, and/or manipulation of items. Such functionality is referred to herein as “management” of items. IMS 410 also typically interacts with file system (“FS”) 480 and with database management system (“DBMS”) 490 and maintains tables and the like such as table 300 described in connection with FIG. 3. IMS 410 may be implemented as a software module or process or set of processes, and may operate in a user mode and/or a protected mode of an operating system or the like.

File handle list (“FHL”) 412 typically provides functionality for managing, accessing, and controlling a list of file handles and other information associated with file items being managed by IMS 410. FHL 412 typically includes tables, lists, data structures, and/or the like, including information associated with file items managed by IMS 410. IMS 410 typically interacts with FHL 412 to populate the list for any file item created, managed, accessed, or such by system 400. The list typically includes information about the file item such as the name of the file item, a path indicating the storage location of the file item as stored in FS 480, a corresponding file item ID, as well as a list of any open file handles associated with the file item. Such file handles are typically provided or returned by file system 480 as the result of file open operations, file create operations, or the like. Such operations are termed herein file handle requests. In one example, FHL 412 may be implemented as a database table. In another example, FHL 412 may be implemented as a data structure maintained in system memory in the form of a cache or the like.

Item management interface (“IMI”) 420 typically provides an application programming interface (“API”) or the like sufficient for applications, such as example application 470, to interact with IMS 410 and system 400. IMI 420 may be implemented as any conventional or special-purpose interface sufficient to provide access to IMS 410 functionality.

Item management file system interface (“IMFSI”) 430 typically provides an interface for FS 480 to interact with IMS 410 and FHL 412. IMFSI 430 is typically used by FS 480 to, among other things, access FHL 412 and to take and release locks on items. IMFSI 430 may be implemented as any conventional or special-purpose interface sufficient to provide access to IMS 410 and FHL 412 functionality. In one example, IMFSI may be implemented as a driver module.

File system (“FS”) 480 is typically a conventional file system such as that provided by a typical operating system. Such a file system may be associated with system 400 only by its usage by such a system. Alternatively, FS 480 may be an integral part of system 400. FS 480 typically provides all the functionality required for managing, accessing, and controlling files and stores such files in file storage 482, which may be any suitable storage system and/or mechanism.

Database management system (“DBMS”) 490 is typically a conventional DBMS system. Such a database system may be associated with system 400 only by its usage by such a system. Alternatively, DBMS 490 may be an integral part of system 400. DBMS 490 typically provides all the functionality required for managing, accessing, and controlling database information, such as tables and records, and stores such information in database storage 492, which may be any suitable storage system.

FIG. 5 is a block diagram showing an example LockRootItem method 500 typically used by an application or the like, such as example application 470 as described in connection with FIG. 4, in requesting a lock on an item. The name “LockRootItem” is simply an example name—any suitable name or identifier may be used for the method. In one example, such a LockRootItem method is used any time access to an item is desired. That is, any and all access to an item is preceded by a call to LockRootItem method 500. A LockRootItem method may be implemented as a software procedure, library routine, subroutine, method, process, driver, logic circuit, or the like. A LockRootItem method entry point or the like, as indicated by block 510, is typically called prior to accessing an item or any element of an item or the like. Item access may include reading, writing, modifying, deleting, or any other form of access. Such a LockRootItem method is typically called using an ItemID of the item or element for which access is desired. If the root item of the desired item is not already locked, then LockRootItem method 500 typically locks the root item on behalf of the caller and returns an indication that access to the item is allowed. If the root item of the desired item is already locked, then LockRootItem method 500 typically denies the lock request indicating that access to the desired item is not allowed. A pre-existing lock on a root item typically indicates that some element of the item is currently being accessed by some other process or caller. If the desired item is locked, method 500 may wait a timeout interval for the pre-existing lock owner to release the pre-existing lock, returning a timeout error if the pre-existing lock is not released during the timeout interval. Once a caller commits or rolls back any changes to an item, the lock is typically released.

Block 520 indicates using the ItemID of the item to be accessed to look up the desired item in a table, such as table 300 of FIG. 3. The desired item, which is associated with the ItemID, may be a child item or element of a compound item, or may be the root item of a compound item. Alternatively, the desired item may be a non-compound item with only a single element. In any case, the ItemID provided when making the LockRootItem call typically identifies the item for which access is desired and is used to look up the desired item in a table, such as table 300 of FIG. 3. Once the desired item is looked up using the provided ItemID, method 500 typically continues at block 530.

Block 530 indicates looking up the RootItemID of the desired item. This is typically done by accessing the RootItemID column of the row corresponding to the ItemID of the desired item. The information in this row/column of the table typically identifies the ItemID of the root item of the desired item. For example, if the desired item is item ‘D’ as shown in column 301 of FIG. 3, then the RootItemID is ‘A’ as shown, which corresponds to the root item of column 302 of FIG. 3. In some cases, such as with a non-compound item with a single element, the ItemID and the RootItemID may be the same. Once the RootItemID of the desired item has been looked up, method 500 typically continues at block 540.

Block 540 indicates a test to determine if the root item of the desired item is locked. This test is typically performed by checking the Lock column of the row associated with the root item. For example, if the root item is item ‘A’ as shown in row 302 of FIG. 3, then the entry in the Lock column of table 300 associated with row 302 is checked for a lock indication. In an additional and/or alternate example, the test may determine if the desired item is locked. If the root item is locked, then method 500 typically continues at block 550. If the root item is not locked, the method 500 typically continues at block 560.

Block 550 indicates denying the lock request for the desired item and indicating such back to the caller. Such a denial generally occurs because the root item of the desired item is already locked, indicating some element of the item is already being accessed by some other process or caller. If the desired item is already locked, method 500 may wait a timeout interval for the pre-existing lock owner to release the pre-existing lock, returning a timeout error if the pre-existing lock is not released during the timeout interval. Otherwise, another LockRootItem request may be made at a future time and may succeed if the root item of the desired item is no longer locked. Returning such a denial typically terminates LockRootItem method 500.

Block 560 indicates placing a lock on the root item of the desired item. This is typically done by indicating a lock in the Lock column of the row associated with the root item. Once the root item is locked, method 500 typically continues at block 570.

Block 570 indicates placing a lock on the desired item. This is typically done by indicating a lock in the Lock column of the row associated with the desired item. In alternate examples, the desired item may not receive a lock indication. Once the desired item is locked, method 500 typically continues at block 580.

Block 580 indicates returning a lock indication to the caller. Such an indication serves to notify the caller that the requested lock has been granted and that the desired item may be accessed by the caller. In alternate examples, the lock indication may serve to notify the caller that the requested lock has been granted and that any element of the root item associated with the desired item may be accessed by the caller. Returning such a lock indication typically terminates LockRootItem method 500.

FIG. 6 is a block diagram showing an example FSLockRootItem method 600 typically used by a file system or the like, such as file system 480 described in connection with FIG. 4, when opening a file handle for a file item. The name “FSLockRootItem” is simply an example name—any suitable name or identifier may be used for the method. In one example, such an FSLockRootItem method is used any time the file system attempts to open file handle for a file item. That is, any and all attempts to open a file handle for a file item are preceded by a call to FSLockRootItem method 600. An FSLockRootItem method may be implemented as a software procedure, library routine, subroutine, method, process, driver, logic circuit, or the like. An FSLockRootItem method entry point or the like, as indicated by block 610, is typically called prior to the file system opening a file handle to a file item. Such an FSLockRootItem method is typically called by the file system using a file name and/or path of the file item for which a file handle is desired. The FSLockRootItem method generally returns a return value to the caller indicating success or failure, success indicating a file handle for the file item may be opened and failure indicating a file handle for the file item may not be opened.

Block 620 indicates locking the root item of the file item for which a handle is desired. In one example, this may be accomplished by calling the LockRootItem method described in connection with FIG. 5. In the event that the root item associated with the file item is already locked, method 600 may continue at block 660. Once a lock is successfully taken on the root item of the file item, process 600 continues at block 630.

Block 630 indicates looking up the file item in a list such as the file handle list described in connection with FIG. 4. If the file item does not exist in the list, an associated table, such as table 300 described in connection with FIG. 3, may be searched for the file item and, if found, a list entry created with information about the file item from the table. If no table entry for the file item is found, such as in the case of a new file being created, a list entry may be created using information provided by the file system via the FSLockRootItem call. Once information regarding the file item is available in the list, method 600 typically continues at block 640.

Block 640 indicates checking the file item information in the list for any open file handles. If there are no open file handles associated with the file item, method 600 typically continues at block 650. If there are any open file handles associated with the file item, then method 600 typically continues at block 660.

Block 650 indicates setting the return value of the FSLockRootItem method to “Pass”, indicating that a file handle may be opened for the file item. Any suitable value or indication may be used to indicate “Pass”. Once the return value is set to indicate “Pass”, method 600 typically continues at block 670.

Block 660 indicates setting the return value of FSLockRootItem method to “Fail”, indicating that a file handle may not be opened for the file item. Any suitable value or indication may be used to indicate “Fail”. Once the return value is set to indicate “Fail”, method 600 typically continues at block 670.

Block 670 indicates releasing the lock taken on the root item of the file item. Once the lock is released, method 600 typically continues at block 680.

Block 680 indicates returning the return value set at either block 650 or 660 to the caller.

Method 500 described in connection with FIG. 5 may be augmented based on the operation of method 600 to also look for any open file handles when determining whether or not a lock may be taken on an item. For example, the step of method 500 indicated by block 540 of FIG. 5 may be augmented to also check for any open file handles and, if there are any open file handles, denying the lock request even if the root item is not locked.

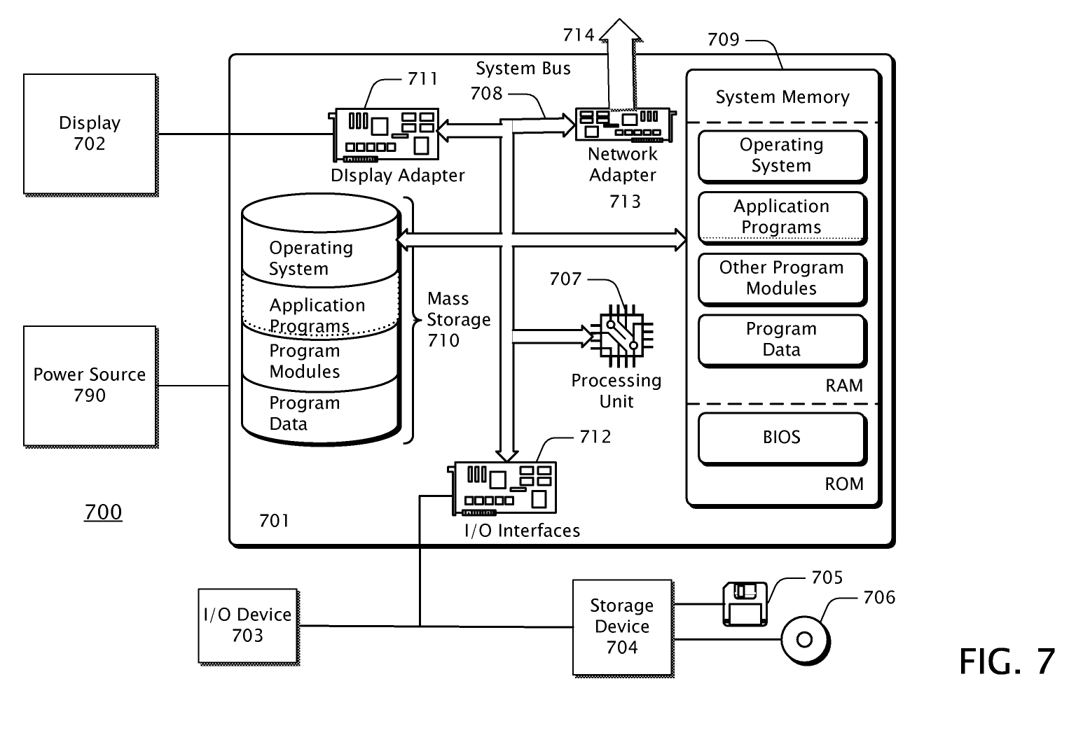

FIG. 7 is a block diagram showing an example computing environment 700 in which the technologies described above may be implemented. A suitable computing environment may be implemented with numerous general purpose or special purpose systems. Examples of well known systems may include, but are not limited to, cell phones, personal digital assistants (“PDA”), personal computers (“PC”), hand-held or laptop devices, microprocessor-based systems, multiprocessor systems, servers, workstations, consumer electronic devices, set-top boxes, and the like.

Computing environment 700 typically includes a general-purpose computing system in the form of a computing device 701 coupled to various components, such as peripheral devices 702, 703, 704 and the like. System 700 may couple to various other components, such as input devices 703, including voice recognition, touch pads, buttons, keyboards and/or pointing devices, such as a mouse or trackball, via one or more input/output (“I/O”) interfaces 712. The components of computing device 701 may include one or more processors (including central processing units (“CPU”), graphics processing units (“GPU”), microprocessors (“μP”), and the like) 707, system memory 709, and a system bus 708 that typically couples the various components. Processor 707 typically processes or executes various computer-executable instructions to control the operation of computing device 701 and to communicate with other electronic and/or computing devices, systems or environment (not shown) via various communications connections such as a network connection 714 or the like. System bus 708 represents any number of several types of bus structures, including a memory bus or memory controller, a peripheral bus, a serial bus, an accelerated graphics port, a processor or local bus using any of a variety of bus architectures, and the like.

System memory 709 may include computer readable media in the form of volatile memory, such as random access memory (“RAM”), and/or non-volatile memory, such as read only memory (“ROM”) or flash memory (“FLASH”). A basic input/output system (“BIOS”) may be stored in non-volatile or the like. System memory 709 typically stores data, computer-executable instructions and/or program modules comprising computer-executable instructions that are immediately accessible to and/or presently operated on by one or more of the processors 707.

Mass storage devices 704 and 710 may be coupled to computing device 701 or incorporated into computing device 701 via coupling to the system bus. Such mass storage devices 704 and 710 may include non-volatile RAM, a magnetic disk drive which reads from and/or writes to a removable, non-volatile magnetic disk (e.g., a “floppy disk”) 705, and/or an optical disk drive that reads from and/or writes to a non-volatile optical disk such as a CD ROM, DVD ROM 706. Alternatively, a mass storage device, such as hard disk 710, may include non-removable storage medium. Other mass storage devices may include memory cards, memory sticks, tape storage devices, and the like.

Any number of computer programs, files, data structures, and the like may be stored in mass storage 710, other storage devices 704, 705, 706 and system memory 709 (typically limited by available space) including, by way of example and not limitation, operating systems, application programs, data files, directory structures, computer-executable instructions, and the like.

Output components or devices, such as display device 702, may be coupled to computing device 701, typically via an interface such as a display adapter 711. Output device 702 may be a liquid crystal display (“LCD”). Other example output devices may include printers, audio outputs, voice outputs, cathode ray tube (“CRT”) displays, tactile devices or other sensory output mechanisms, or the like. Output devices may enable computing device 701 to interact with human operators or other machines, systems, computing environments, or the like. A user may interface with computing environment 700 via any number of different I/O devices 703 such as a touch pad, buttons, keyboard, mouse, joystick, game pad, data port, and the like. These and other I/O devices may be coupled to processor 707 via I/O interfaces 712 which may be coupled to system bus 708, and/or may be coupled by other interfaces and bus structures, such as a parallel port, game port, universal serial bus (“USB”), fire wire, infrared (“IR”) port, and the like.

Computing device 701 may operate in a networked environment via communications connections to one or more remote computing devices through one or more cellular networks, wireless networks, local area networks (“LAN”), wide area networks (“WAN”), storage area networks (“SAN”), the Internet, radio links, optical links and the like. Computing device 701 may be coupled to a network via network adapter 713 or the like, or, alternatively, via a modem, digital subscriber line (“DSL”) link, integrated services digital network (“ISDN”) link, Internet link, wireless link, or the like.

Communications connection 714, such as a network connection, typically provides a coupling to communications media, such as a network. Communications media typically provide computer-readable and computer-executable instructions, data structures, files, program modules and other data using a modulated data signal, such as a carrier wave or other transport mechanism. The term “modulated data signal” typically means a signal that has one or more of its characteristics set or changed in such a manner as to encode information in the signal. By way of example, and not limitation, communications media may include wired media, such as a wired network or direct-wired connection or the like, and wireless media, such as acoustic, radio frequency, infrared, or other wireless communications mechanisms.

Power source 790, such as a battery or a power supply, typically provides power for portions or all of computing environment 700. In the case of the computing environment 700 being a mobile device or portable device or the like, power source 790 may be a battery. Alternatively, in the case computing environment 700 is a desktop computer or server or the like, power source 790 may be a power supply designed to connect to an alternating current (“AC”) source, such as via a wall outlet.

Some mobile devices may not include many of the components described in connection with FIG. 7. For example, an electronic badge may be comprised of a coil of wire along with a simple processing unit 707 or the like, the coil configured to act as power source 790 when in proximity to a card reader device or the like. Such a coil may also be configure to act as an antenna coupled to the processing unit 707 or the like, the coil antenna capable of providing a form of communication between the electronic badge and the card reader device. Such communication may not involve networking, but may alternatively be general or special purpose communications via telemetry, point-to-point, RF, IR, audio, or other means. An electronic card may not include display 702, I/O device 703, or many of the other components described in connection with FIG. 7. Other mobile devices that may not include many of the components described in connection with FIG. 7, by way of example and not limitation, include electronic bracelets, electronic tags, implantable devices, and the like.

Those skilled in the art will realize that storage devices utilized to provide computer-readable and computer-executable instructions and data can be distributed over a network. For example, a remote computer or storage device may store computer-readable and computer-executable instructions in the form of software applications and data. A local computer may access the remote computer or storage device via the network and download part or all of a software application or data and may execute any computer-executable instructions. Alternatively, the local computer may download pieces of the software or data as needed, or distributively process the software by executing some of the instructions at the local computer and some at remote computers and/or devices.

Those skilled in the art will also realize that, by utilizing conventional techniques, all or portions of the software's computer-executable instructions may be carried out by a dedicated electronic circuit such as a digital signal processor (“DSP”), programmable logic array (“PLA”), discrete circuits, and the like. The term “electronic apparatus” may include computing devices or consumer electronic devices comprising any software, firmware or the like, or electronic devices or circuits comprising no software, firmware or the like.

The term “firmware” typically refers to executable instructions, code, data, applications, programs, or the like maintained in an electronic device such as a ROM. The term “software” generally refers to executable instructions, code, data, applications, programs, or the like maintained in or on any form of computer-readable media. The term “computer-readable media” typically refers to system memory, storage devices and their associated media, and the like.

In view of the many possible embodiments to which the principles of the present invention and the forgoing examples may be applied, it should be recognized that the examples described herein are meant to be illustrative only and should not be taken as limiting the scope of the present invention. Therefore, the invention as described herein contemplates all such embodiments as may come within the scope of the following claims and any equivalents thereto.

1. A system for locking a compound item comprising:
an item management system operable to embody the compound item in a table and to lock the compound item so as to preserve integrity of the compound item wherein the compound item is comprised of a container and a plurality of items organized in a hierarchical structure;
an item management interface coupled to the item management system and operable to provide an application access to the compound item; and
a coupling between the item management system and a database management system, the coupling sufficient for the item management system to store and access the table in a database store of the database management system.

2. The system of claim 1 wherein the compound item is further comprised of a file item.

3. The system of claim 2 further comprising a coupling between the item management system and a file system, the coupling sufficient for the item management system to store and access the file item in a file store of the file system.

4. The system of claim 3 further comprising:
a file handle list comprising any open file handles and a file item identifier and a file name and a path, each associated with the file item; and
an item management file system interface coupled to the item management system and the file handle list and operable to provide the application access to the file item via the file system.

5. The system of claim 1 wherein the compound item is further comprised of a fragment.

6. The system of claim 4 wherein the table includes an item identifier associated with a root item identifier and associated with a lock indicator, each associated with the file item.

7. The system of claim 6 wherein the file item is stored in the file store of the file system.

8. The system of claim 1 wherein access by the application to an element of the compound item results in the item management system taking a lock on the compound item, the lock preventing a second application for accessing the compound item.

9. A method for taking a lock on a compound item, the method comprising:
receiving a lock request including an item identifier associated with a desired element of the compound item;
looking up the desired element using the item identifier;
looking up a root item identifier associated with the item identifier;
examining a lock indicator associated with the root item identifier to determine if the compound item is currently locked, wherein the two looking up steps prior to the examining step are sufficient for the examining step to determine if the compound item is currently locked; and
if the compound item is currently locked, denying the lock request or, if the compound item is not currently locked, taking the lock on the compound item.

10. The method of claim 9 further comprising marking the desired element associated with the item identifier as locked.

11. The method of claim 9 embodied as computer-executable instructions stored on a computer readable medium.

12. The method of claim 9 further comprising releasing the lock on the compound item when a commit operation is performed on the compound item.

13. The method of claim 12 embodied as computer-executable instructions stored on a computer readable medium.

14. A method for taking a lock to control access by a file system to a file item associated with a compound item, the method comprising:
receiving a file handle request including a file name associated with the file item;
taking a lock on a root item of the compound item;
looking up the file name in a file handle table;
examining an entry associated with the file name in the file handle table to determine if an open file handle exists in the entry;
releasing the lock on the root item; and
if an open file handle exists in the entry, denying the file handle request or, if no open file handle exists in the entry, approving the file handle request.

15. The method of claim 14 wherein the entry includes the file name and an associated item identifier and an associated path.

16. The method of claim 15 wherein the path indicates the location at which the file item is stored by the file system.

17. The method of claim 14 wherein the file handle table is maintained in system memory.

18. The method of claim 14 further comprising checking for a lock on the root item prior to the step of taking a lock on the root item and, if a lock exists, denying the file handle request.

19. The method of claim 14 further comprising removing the open file handle from the entry upon a close operation associated with the file name.

20. The method of claim 14 embodied as computer-executable instructions stored on a computer-readable medium.
